(19) United States
(12) Patent Application Publication
(10) Pub. No.: US 2008/0222953 A1
(43) Pub. Date: Sep. 18, 2008

(54) Sheets of material having a first printed pattern on an upper surface thereof and a second printed pattern on a lower surface thereof

(76) Inventor: Donald E. Weder, Highland, IL (US)

Correspondence Address: DUNLAP CODDING, P.C., PO BOX 16370, OKLAHOMA CITY, OK, 73113, US

(21) Appl. No.: 12/154,092

(22) Filed: May 20, 2008

Related U.S. Application Data
(63) Continuation of application No. 11/156,746, filed on Jun. 20, 2005, now abandoned.
Application No. 11/156,746 is a continuation of application No. 10/406,451, filed on Apr. 3, 2003, now abandoned.
Application No. 10/406,451 is a division of application No. 10/278,588, filed on Oct. 21, 2002, now abandoned.
Application No. 10/278,588 is a continuation-in-part of application No. 10/300,295, filed on Nov. 19, 2002, now abandoned.
Application No. 10/278,588 is a continuation of application No. 09/804,275, filed on Mar. 12, 2001, now abandoned.
Application No. 10/406,451 is a continuation-in-part of application No. 10/300,295, filed on Nov. 19, 2002, now abandoned.
Application No. 10/300,295 is a division of application No. 10/183,786, filed on Jun. 26, 2002, now Pat. No. 6,564,507.
Application No. 10/183,786 is a continuation of application No. 10/051,828, filed on Jan. 17, 2002, now abandoned.
Application No. 10/051,828 is a continuation of application No. 09/606,812, filed on Jun. 28, 2000, now Pat. No. 6,347,480.
Application No. 09/606,812 is a continuation-in-part of application No. 08/888,813, filed on Jul. 7, 1997, now abandoned.
Application No. 08/888,813 is a division of application No. 08/480,657, filed on Jun. 7, 1995, now Pat. No. 5,752,360.
Application No. 08/480,657 is a continuation of application No. 08/084,050, filed on Jun. 29, 1993, now abandoned.

(51) Int. Cl. A01G 9/02

(52) U.S. Cl. 47/72

(57) ABSTRACT

Sheets of material having a first printed pattern or color disposed on or visible through an upper surface thereof and a second printed pattern or color disposed on or visible through a lower surface thereof are disclosed, as well as methods for producing same. Such sheets of material may be employed to provide a decorative cover for a floral grouping or a decorative cover for a flower pot; or to form a preformed flower pot cover for covering a flower pot; or to provide a sleeve for wrapping or covering a floral grouping or a flower pot; or to provide a ribbon material. The sheets of material of the present invention may be constructed of a single layer of material or multiple layers of material.

### CROSS REFERENCE TO RELATED APPLICATIONS

This application is a continuation of U.S. Ser. No. 11/156,746, filed Jun. 20, 2005, now abandoned; which is a continuation of U.S. Ser. No. 10/406,451, filed Apr. 3, 2003, now abandoned. Said application U.S. Ser. No. 10/406,451 is simultaneously a divisional of U.S. Ser. No. 10/278,588, filed Oct. 21, 2002, now abandoned; and a continuation-in-part of U.S. Ser. No. 10/300,295, filed Nov. 19, 2002, now abandoned. Said U.S. Ser. No. 10/278,588 is a continuation of U.S. Ser. No. 09/804,275, filed Mar. 12, 2001, now abandoned. Said U.S. Ser. No. 10/300,295 is a divisional of U.S. Ser. No. 10/183,786, filed Jun. 26, 2002, now U.S. Pat. No. 6,564,507, issued May 20, 2003; which is a continuation of U.S. Ser. No. 10/051,828, filed Jan. 17, 2002, now abandoned; which is a continuation of U.S. Ser. No. 09/606,812, filed Jun. 28, 2000, now U.S. Pat. No. 6,347,480, issued Feb. 19, 2002; which is a continuation-in-part of U.S. Ser. No. 08/888,813, filed Jul. 7, 1997, now abandoned; which is a divisional of U.S. Ser. No. 08/480,657, filed Jun. 7, 1995, now U.S. Pat. No. 5,752,360, issued May 19, 1998; which is a continuation of U.S. Ser. No. 08/084,050, filed Jun. 29, 1993, now abandoned. The entire contents of each of the above-referenced patents and patent applications are hereby expressly incorporated herein by reference.

### STATEMENT REGARDING FEDERALLY SPONSORED RESEARCH OR DEVELOPMENT

Not applicable.

### FIELD OF THE INVENTION

The present invention relates to sheets of materials having printed patterns thereon, and more particularly but not by way of limitation, to flower pot covers, floral wrappings, and ribbon materials formed from sheets of materials having a first printed pattern on an upper surface thereof and a second printed pattern on a lower surface thereof. In one aspect, the present invention relates to methods for producing flower pot covers and methods of wrapping floral groupings and flower pots with a sheet of material having a first printed pattern on an upper surface thereof and a second printed pattern on a lower surface thereof to provide a decorative cover for such floral groupings and flower pots.

### BRIEF DESCRIPTION OF THE DRAWINGS

FIG. 1 is a perspective view of a sheet of material having a first printed pattern on at least a portion of an upper surface thereof and a second printed pattern on at least a portion of a lower surface thereof constructed in accordance with the present invention, one corner of the sheet of material being turned upwardly.

FIG. 2 is a perspective view of a decorative cover positioned about a flower pot wherein the decorative cover is formed from the sheet of material of FIG. 1.

FIG. 3 is a cross-sectional view of a flower pot cover former and band applicator apparatus having the sheet of material of FIG. 1 disposed above an opening of the flower pot cover former and band applicator and having a flower pot disposed above the sheet of material.

FIG. 4 is a perspective view of a sheet of material having a first printed pattern on at least a portion of an upper surface thereof and a second printed pattern on at least a portion of a lower surface thereof and having a bonding material disposed along one edge thereof, one corner of the sheet of material being turned upwardly.

FIG. 5 is a perspective view of the sheet of material of FIG. 4 having a floral grouping disposed thereon.

FIG. 6 is a perspective view of the sheet of material of FIG. 4 being wrapped about the floral grouping of FIG. 5 by one method of wrapping.

FIG. 7 is a perspective view of a decorative cover for the floral grouping of FIG. 5 formed from the sheet of material of FIG. 4 wherein the decorative cover has a conical configuration.

FIG. 8 is a perspective view of a decorative cover for a floral grouping formed from the sheet of material of FIG. 4 wherein the decorative cover has a substantially cylindrical configuration.

FIG. 9A is a perspective view of a sheet of polymeric film having a first printed pattern on at least a portion of an upper surface thereof and a second printed pattern on at least a portion of a lower surface thereof and an acrylic heat sealable lacquer disposed on at least a portion of the lower surface thereof such that the second printed pattern is visible through the acrylic heat sealable lacquer, one corner of the sheet of expanded core polymeric film being upwardly turned.

FIG. 9B is a perspective view of a laminated sheet of material having a first printed pattern on at least a portion of an upper surface thereof and a second printed pattern on at least a portion of a lower surface thereof, one corner of the laminated sheet of material being upwardly turned.

FIG. 10 is a perspective view of a decorative preformed flower pot cover formed from a sheet of material having a first printed pattern on at least a portion of an upper surface thereof and a second printed pattern on at least a portion of a lower surface thereof.

FIG. 11 is a perspective view of the decorative preformed flower pot cover of FIG. 10 having a flower pot disposed therein.

FIG. 12 is a diagrammatic, cross-sectional view of a male and female mold having the sheet of polymeric film of FIG. 9A disposed therebetween for forming the decorative preformed flower pot cover of FIG. 10.

FIG. 13 is a perspective view of a floral sleeve formed from a sheet of material having a first printed pattern on at least a portion of an outer peripheral surface thereof and a second printed pattern on at least a portion of an inner peripheral surface thereof.

FIG. 14 is a perspective view of the floral sleeve of FIG. 13 disposed about a floral grouping.

FIG. 15 is a perspective view of a floral sleeve having a cinching member wherein the floral sleeve is formed from a sheet of material having a first printed pattern on at least a portion of an outer peripheral surface thereof and a second printed pattern on at least a portion of an inner peripheral surface thereof.

FIG. 16 is a perspective view of the floral sleeve of FIG. 15 disposed about a floral grouping.

FIG. 17 is an elevational view of a sleeve having a detachable upper portion wherein the sleeve is formed from a sheet of material having a first printed pattern on at least a portion of an outer peripheral surface thereof and a second printed pattern on at least a portion of an inner peripheral surface thereof.

FIG. 18 is a perspective view of the sleeve of FIG. 17 having a flower pot disposed therein.

FIG. 19 is a perspective view of a flower pot disposed in the sleeve of FIG. 17 wherein the detachable upper portion of the sleeve has been removed to provide a decorative cover having a skirt.

FIG. 20A is a perspective view of a polymeric ribbon material having a first printed pattern on at least a portion of an upper surface thereof and a second printed pattern on at least a portion of a lower surface thereof.

FIG. 20B is a perspective view of a polymeric ribbon material having a first printed pattern on at least a portion of an upper surface thereof and a second printed pattern on at least a portion of a lower surface thereof.

FIG. 20C is a perspective view of a laminated polymeric ribbon having a first printed pattern on at least a portion of an upper surface thereof an a second printed pattern on at least a portion of a lower surface thereof.

### DETAILED DESCRIPTION OF THE INVENTION

The present invention comprises a sheet of material having a first printed pattern disposed on an upper surface thereof and a second printed pattern disposed on a lower surface thereof. The sheet of material of the present invention may be employed to provide a decorative cover for a floral grouping or a decorative cover for a flower pot; or to form a preformed flower pot cover for covering a flower pot; or to provide a sleeve for wrapping or covering a floral grouping or a flower pot; or to provide a ribbon material. The sheet of material of the present invention may be constructed of a single layer of material or multiple layers of material. However, it is to be understood that while the decorative cover for a floral grouping or a flower pot, the sleeve for a floral grouping or a flower pot, the preformed flower pot cover, and ribbon material of the present invention are described herein and depicted in the drawings as being formed of a specific sheet of material, such as a single layered sheet of material, a plurality of sheets of material or a sheet of laminated material, any sheet of material described herein may be utilized to form a decorative cover for a floral grouping or a flower pot, the sleeve for a floral grouping or a flower pot, the preformed flower pot cover, and ribbon material, and therefore the description and drawings should not be construed as limiting.

The term “flower pot” as used herein refers to any type of container for holding a floral grouping, or a plant, or even another pot-type container. Examples of flower pots and/or pot-type containers include clay pots, wooden pots, plastic pots, pots made from natural and/or synthetic fibers, or any combination thereof. Such flower pots and/or pot-type containers are provided with a retaining space for receiving a floral grouping. The floral grouping may be disposed within the retaining space of the flower pot with a suitable growing medium described in further detail below, or other retaining medium, such as a floral foam. It will also be understood that in some cases the floral grouping, and any appropriate growing medium or other retaining medium, may be disposed in a sleeve formed from a sheet of material of the present invention if the sleeve is adapted to contain a medium.

“Floral grouping” as used herein refers to cut fresh flowers, artificial flowers, a single flower or other fresh and/or artificial plants or other floral materials and may include other secondary plants and/or ornamentation or artificial or natural materials which add to the aesthetics of the overall floral grouping. Further, the floral grouping may comprise a growing potted plant having a root portion as well. However, it will be appreciated that the floral grouping may consist of only a single bloom or only foliage, or a botanical item (not shown), or a propagule. The term “floral grouping” may be used interchangeably herein with the term “floral arrangement”. The term “floral grouping” may also be used interchangeably herein with the terms “botanical item” and/or “propagule.”

The term “growing medium” when used herein refers to any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

The term “botanical item” when used herein includes a natural or artificial herbaceous or woody plant, taken singularly or in combination. The term “botanical item” also includes any portion or portions of natural or artificial herbaceous or woody plants including stems, leaves, flowers, blossoms, buds, blooms, cones, or roots, taken singularly or in combination, or in groupings of such portions such as bouquets or floral groupings.

The term “propagule” when used herein refers to any structure capable of being propagated or acting as an agent of reproduction including seeds, shoots, stems, runners, tubers, plants, leaves, roots or spores.

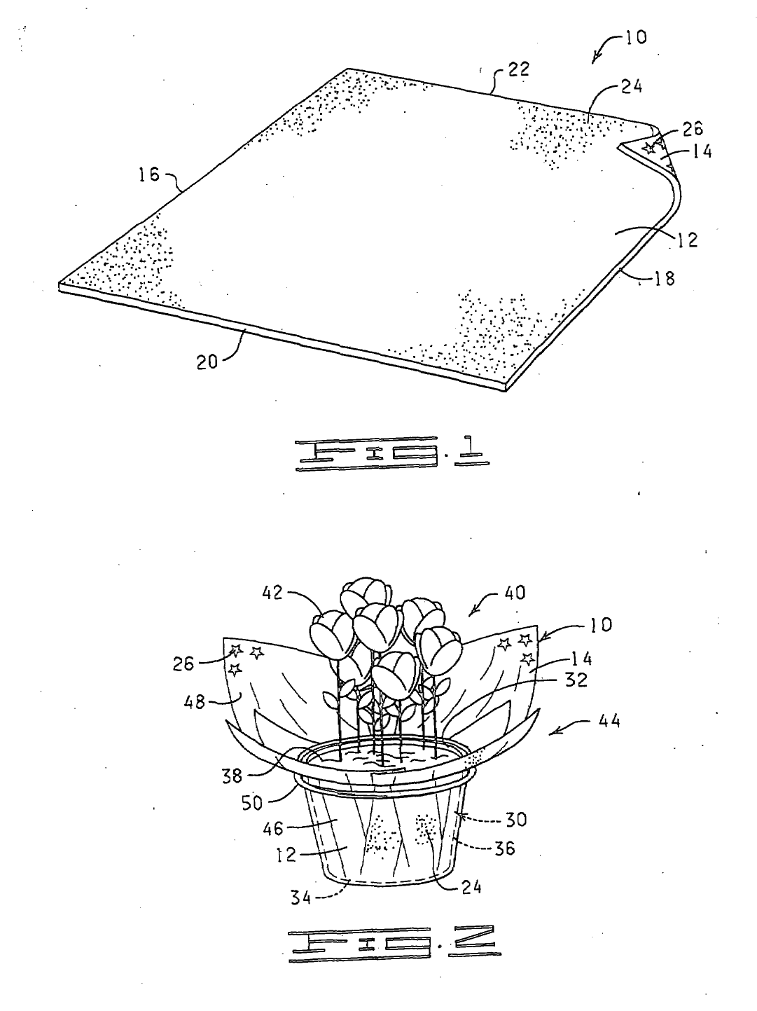

### Description of FIGS. 1-3

Referring now to FIGS. 1 and 2, designated generally by the reference numeral 10 is a sheet of material having an upper surface 12, a lower surface 14, a first side 16, a second side 18, a third side 20, and a fourth side 22. The sheet of material 10 is also provided with a first printed pattern 24 disposed on at least a portion of the upper surface 12 thereof and a second printed pattern 26 disposed on at least a portion of the lower surface 14 thereof.

The first and second printed patterns 24 and 26 may each be a solid color or a pattern comprising one or more colors. For example, the first and second printed patterns 24 and 26 may be any shape, design, or form, including any geometric form or combination of geometric forms, such as squares, round spots, triangles, rectangles, octagonals, or the like, or any non-geometric, asymmetrical or fanciful forms or any combination thereof, including hearts, balloons, flowers, lace, slogans, logos, print (any combination of letters and/or numbers), signs, human forms (real and fictional), animal forms (real and fictional), cartoon characters, works of art, musical scores and/or plant and floral shapes generally associated with botanical items such as leaves, petals, stems, roots, fruits and any other biomorphic shapes. The first and second printed patterns 24 and 26 may include a single color or a plurality of colors.

The first and second printed patterns 24 and 26 may be the same or different patterns. When the same pattern is utilized as the first and second printed patterns 24 and 26, the first printed pattern 24 may be a different color than the second printed pattern 26, or the first and second printed patterns 24 and 26 may be the same pattern and the same color. Optionally, the first and second printed patterns 24 and 26 may be the same color but different patterns, or the first printed pattern 24 may be a different pattern and a different color than the second printed pattern 26. In a further alternative, the first and second printed patterns 24 and 26 may each comprise a plurality of colors, and at least a portion of the colors may be the same and a portion of the colors may be different, or the plurality of colors may all be the same or all be different. When the first and second printed patterns 24 and 26 comprise a plurality of colors, the patterns may be the same or different.

In yet another alternative, one of the first and second printed patterns 24 and 26 may comprise a solid color and the other of the first and second printed patterns 24 and 26 may comprise a plurality of colors, wherein the solid color of the other printed pattern 24 or 26 may or may not be included in the plurality of colors. In this alternative, the patterns of the first and second printed patterns 24 and 26 may be the same or different. For example, the first printed pattern 24 may have a flower design printed thereon wherein the leaves and stems of the flower are green and a bloom portion of the flower is red. The second printed pattern 24 may have a leaf design printed thereon in the same shade of green as the leaves and stems of the flower of the first printed pattern 24. In an alternate example, the first printed pattern 24 may have a Christmas tree design in green and red, and the second printed pattern 26 may have a logo, such as “Merry Christmas”, printed in gold.

The sheet of material 10 may be constructed of any material which functions in accordance with the present invention. Preferably, the sheet of material 10 is constructed of paper, polymeric film, metallized film, foil, cloth or combinations or laminations thereof.

Any thickness or stiffness of the sheet of material 10 may be utilized in accordance with the present invention as long as the sheet of material 10 can be wrapped about at least a portion of a floral grouping or a flower pot, as described herein. Generally, the sheet of material 10 will have a thickness of from about 0.1 mil to about 30 mil, and more desirably from about 0.5 mil to about 10 mil.

The term “polymeric film” as used herein includes synthetic polymers such as polypropylene, polyethylene or polyvinyl chloride, extruded polymeric materials having an expanded core such as extruded polypropylene having an expanded core, naturally occurring polymers such as cellophane, and combinations thereof. The extruded polymeric material having an expanded core may also be referred to herein as an expanded core polymeric material.

“Extruded polymeric material having an expanded core” or “expanded core polymeric film” as used herein refers to any extrudable polymeric material or polymeric film in which the core is expanded during extrusion, such as by incorporation of a blowing agent in the polymeric resin which is being extruded.

The sheet of material 10 may also be constructed, in whole or in part, from a cling material. “Cling material” when used herein refers to any material which is capable of connecting to the sheet of material and/or itself upon contacting engagement during the wrapping process and is wrappable about an item whereby portions of the cling material contactingly engage and connect to other portions of another material, or, alternatively, itself, for generally securing the material wrapped about at least a portion of a flower pot. This connecting engagement is preferably temporary in that the material may be easily removed, i.e., the cling material “clings” to the flower pot.

The cling material is constructed from polyethylene such as Cling Wrap made by Glad®, First Brands Corporation, Danbury, Conn., and the cling material may be treated if necessary. The thickness of the cling material will, in part, depend upon the size of sleeve and the size of the flower pot in the sleeve, i.e., generally, a larger flower pot may require a thicker and therefore stronger cling material. The cling material will range in thickness from about 0.1 mil to about 10 mil, and more desirably from about 0.5 mil to about 2.5 mil.

The term “cloth” as used herein will be understood to include any type of fabric material, including woven fabric, nonwoven fabric, welded fabric, spunbonded fabric, knitted fabric, pressed fabric, other types of fibrous material, and combinations thereof. Examples of cloth include fabrics formed from natural fibers such as cotton, wool, silk, hair, burlap, and linen, as well as synthetic fibers such as rayon and polyester, and blends thereof, such as denim.

In the embodiment shown in FIG. 1, the sheet of material 10 is square. It will be appreciated, however, that the sheet of material 10 can be of any shape, configuration or size as long as the sheet of material 10 is sufficiently sized and shaped to wrap and encompass a floral grouping or a flower pot. For example, the sheet of material 10 may have a rectangular, round, oval, octagonal or asymmetrical shape. Further, multiple sheets of the polymeric material 10 may be used in a single circumstance to provide a decorative cover or sleeve for a floral grouping or a flower pot. Moreover, when multiple sheets of material 10 are used in combination, the sheets of material 10 need not be uniform in size or shape.

The sheet of material 10 may vary in color. Further, the sheet of material 10 may have other decorative patterns or designs which are provided on at least one surface thereof in addition to the first and second printed patterns 24 and 26, and such decorative patterns or designs may be provided by printing, embossing, matting, texturing, flocking, application of foamable lacquers or foamable inks, or variations or combinations thereof.

The sheet of material 10 having the first and second printed patterns 24 and 26 disposed thereon may be used to wrap a flower pot 30, as shown in FIG. 2. The flower pot 30 has an open upper end 32, a lower end 34, an outer peripheral surface 36, and an inner retaining space 38 within which may be disposed a growing medium and/or a plant 40, which has an upper portion 42 comprising blooms or foliage or both.

The sheet of material 10 may be wrapped about the flower pot 30 by any one of numerous methods used to wrap sheets of material about flower pots to form decorative pot covers for flower pots, such as a decorative cover 44 having an outer peripheral surface 46 and an inner peripheral surface 48, as illustrated in FIG. 2. The sheet of material 10 may, for example, be formed by hand about the outer peripheral surface 36 of the flower pot 30 to produce the decorative cover 44. The decorative cover 44 can then be secured about the flower pot 30 by a bonding material such as an elastic band 50 such that the open upper end 32 of the flower pot 30 remains substantially uncovered by the decorative cover 44, substantially as shown in FIG. 2.

The first printed pattern 24 is disposed on the outer peripheral surface 46 of the decorative cover 44 while the second printed pattern 26 is disposed on the inner peripheral surface 48 of the decorative cover 44. At least a portion of the first printed pattern 24 and at least a portion of the second printed pattern 26 are visible on the decorative cover 44.

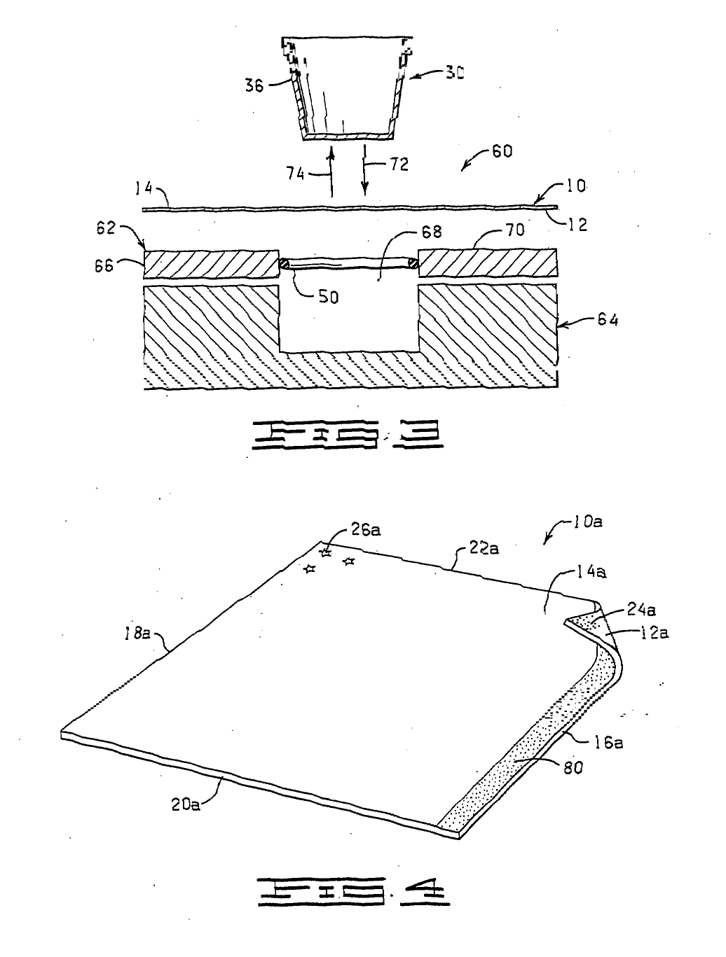

Referring now to FIG. 3, a flower pot cover former and band applicator apparatus 60 for forming the sheet of material 10 into the decorative cover 44 for the flower pot 30 of FIG. 2 is illustrated. The flower pot cover former and band applicator apparatus 60 comprises a band applicator 62 and a flower pot cover former 64. The flower pot cover former and band applicator apparatus 60 has a support platform 66 with an opening 68 formed therein. A band, such as elastic band 50, is disposed circumferentially about the opening 68 in the support platform 66.

The upper surface 12 of the sheet of material 10 is positioned on an upper surface 70 on the support platform 66 such that the sheet of material 10 is positioned over the opening 68 in the support platform 66. The flower pot 30 is positioned above the sheet of material 10 and is moved in a direction 72 into the opening 68 of the flower pot cover former and band applicator apparatus 60. As the flower pot 30 is moved into the opening 68, the sheet of material 10 is pressed about the outer peripheral surface 36 of the flower pot 30, thereby forming the decorative cover 44 (FIG. 2) about the flower pot 30. The decorative cover 44 is then secured about the flower pot 30 by the elastic band 50. The flower pot 30 having the decorative cover 44 secured thereto is then moved in a direction 74 out of the opening 68 in the support platform 66.

The elastic band 50 can be applied manually or automatically such as by the method shown in U.S. Pat. No. 5,105,599 issued Apr. 21, 1992 to Weder, entitled “Means For Securing A Decorative Cover About A Flower Pot”, the specification of which is hereby expressly incorporated herein by reference. The band 50 can also be applied as a tie using a method such as described in “Single Station Covering and Fastening System”, U.S. Pat. No. 5,609,009 issued to Weder et al on Mar. 11, 1997, the specification of which is hereby expressly incorporated herein by reference. The sheet of material 10 can also be applied automatically about the flower pot 30, for example, by methods shown in U.S. Pat. Nos. 4,733,521 and 5,291,721, both of which are hereby expressly incorporated herein by reference.

Instead of securing the decorative cover 44 about the flower pot 30 via the band 50, the decorative cover 44 formed from the sheet of material 10 may be secured to the flower pot 30 by the use of one or more bonding materials. For example, the lower surface 14 of the sheet of material 10 may have a bonding material as described in detail herein after disposed upon a portion thereof. When the sheet of material 10 is disposed about the flower pot 30, at least a portion of the lower surface 14 of the sheet of material 10 contacts the outer peripheral surface 36 of the flower pot 30 and is thereby bonded and held about the flower pot 30 via the bonding material.

The bonding material may cover a portion of the lower surface 14 of the sheet of material 10, or the bonding material may entirely cover the lower surface 14 of the sheet of material 10. The bonding material may be disposed on the lower surface 14 of the sheet of material 10 in the form of a strip or in the form of spaced-apart spots. One method for disposing a bonding material on the sheet of material 10 is described in U.S. Pat. No. 5,111,637, entitled “Method For Wrapping A Floral Grouping”, issued to Weder et al. on May 12, 1992, the specification of which is hereby expressly incorporated herein by reference.

The term “bonding material” when used herein can mean an adhesive, frequently a pressure sensitive adhesive, a cohesive or any adhesive/cohesive combination having adhesive qualities (i.e., qualities of adhesion or adhesion/cohesion, respectively) sufficient to cause the attachment of a portion of the sheet of material 10 to itself, to a floral grouping, or to the flower pot 30. Since the bonding material may comprise either an adhesive or an adhesive/cohesive combination, it will be appreciated that both adhesives and cohesives are known in the art and are commercially available. When the bonding material is a cohesive, a similar cohesive material must be placed on the adjacent surface for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” also includes materials which are sonically sealable and vibratory sealable. The term “bonding material” when used herein also means a heat sealing lacquer or hot melt material which may be applied to the material and, in this instance, heat, sound waves, or vibrations, also must be applied to effect the sealing.

The term “bonding material” when used herein also includes any type of material or thing which can be used to effect the bonding or connecting of the two adjacent portions of the sheet of material 10 to effect the connection or bonding described herein. The term “bonding material” may also include ties, labels, bands, ribbons, strings, tapes (including single or double-sided adhesive tapes), staples or combinations thereof. Some of the bonding materials would secure the ends of the material while other bonding materials may bind the circumference of a cover, or a sleeve, or, alternatively and/or in addition, the bonding materials would secure overlapping folds in the material and/or sleeve. Another way to secure the cover and/or sleeve is to heat seal the ends of the material to another portion of the material. One way to do this is to contact the ends with an iron of sufficient heat to heat seal the material.

Alternatively, a cold seal adhesive may be utilized as the bonding material. The cold seal adhesive adheres only to a similar substrate, acting similarly as a cohesive, and binds only to itself. The cold seal adhesive, since it bonds only to a similar substrate, does not cause a residue to build up on equipment, thereby both permitting much more rapid disposition and use of such equipment to form articles and reducing labor costs. Further, since no heat is required to effect the seal, the dwell time, that is, the time for the sheet of material to form and retain the shape of an article, such as a flower pot cover or flower pot, is reduced. A cold seal adhesive binds quickly and easily with minimal pressure, and such a seal is not readily releasable. This characteristic is different from, for example, a pressure sensitive adhesive.

The term “bonding material” when used herein also includes any heat or chemically shrinkable material, and static electrical or other electrical materials, chemical welding materials, magnetic materials, mechanical or barb-type fastening materials or clamps, curl-type characteristics of the film or materials incorporated in material which can cause the material to take on certain shapes, cling films, slots, grooves, shrinkable materials and bands, curl materials, springs, and any type of welding method which may weld portions of the material to itself or to the flower pot, or to both the material itself and the flower pot.

### Description of FIGS. 4-8

Shown in FIG. 4 is a sheet of material 10a having an upper surface 12a, a lower surface 14a, a first side 16a, a second side 18a, a third side 20a and a fourth side 22a. The upper surface 12a of the sheet of material 10a is provided with a first printed pattern 24a disposed on at least a portion thereof, while the lower surface 14a of the sheet of material 10a is provided with a second printed pattern 26a disposed on at least a portion thereof. The sheet of material 10a is similar to the sheet of material 10 described herein before with reference to FIG. 1, except that the sheet of material 10a is provided with a bonding material 80 disposed on at least a portion of one or both of the upper and lower surfaces 12a and 14a of the sheet of material 10a, such as the lower surface 14a thereof as shown in FIG. 4 and as further illustrated in U.S. Pat. No. 5,181,364 entitled “Wrapping A Floral Grouping With Sheets Having Adhesive or Cohesive Material Applied Thereto”, issued to Weder on Jan. 26, 1993, the specification of which is hereby expressly incorporated by reference herein.

A plurality of sheets of material 10 may be connected together to form a roll as is shown in U.S. Pat. No. 5,459,976, issued Oct. 24, 1995 to Weder et al., entitled “Material And Adhesive Strip Dispenser”, the specification of which is hereby expressly incorporated in its entirety by reference herein.

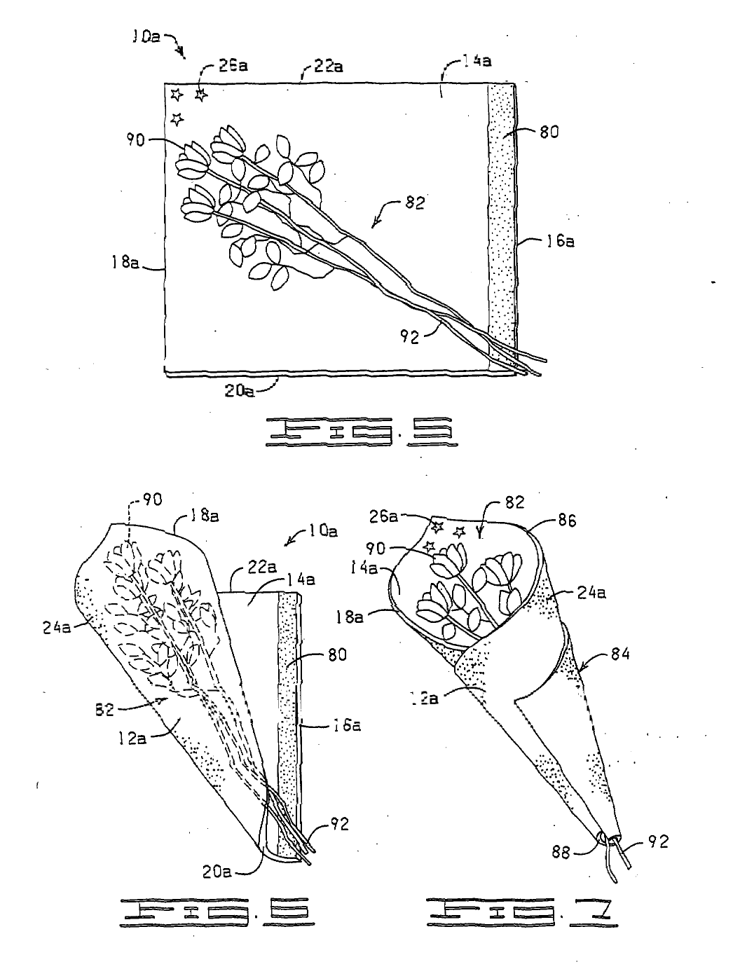

FIGS. 5-7 illustrate the use of the sheet of material 10a to wrap a floral grouping 82 to provide a decorative cover 84 (FIG. 7) for the floral grouping 82, wherein the decorative cover 84 has an open upper end 86 and a lower end 88. The sheet of material 10a may optionally have the strip of bonding material 80 disposed upon the upper surface 12a and/or the lower surface 14a thereof, such as the strip of bonding material 80 disposed along at least a portion of the lower surface 14a of the sheet of material 10a so as to be disposed substantially adjacent the first side 16a thereof and extending substantially between the third and fourth sides 20a and 22a thereof, substantially as shown in FIGS. 5 and 6. Further, the sheet of material 10a can be provided either as an individual sheet or from a pad or roll of material.

The bonding material 80, if present, may have a backing or release strip (not shown). The backing or release strip may be left applied for a period of time to the bonding material 80 after it is disposed on a surface of the sheet of material 10a prior to its use as a wrapping material, to protect the bonding qualities of the bonding strip. In operation, an operator may dispose the sheet of material 10a on a support surface (not shown) such that the upper surface 12a of the sheet of material 10a is in contact with the support surface.

Referring more specifically to FIGS. 5-7, the floral grouping 82 is placed upon the lower surface 14a of the sheet of material 10a in a diagonal orientation. The floral grouping 82 has an upper bloom or foliage portion 90 and a lower stem portion 92. The sheet of material 10a is wrapped about the floral grouping 82 by an operator (FIGS. 6 and 7), the operator overlapping a portion of the sheet of material 10a over another portion of the sheet of material 10a. That is, for example, the operator places the third side 20a of the sheet of material 10a over the floral grouping 82, as shown in FIG. 6. The operator rolls the floral grouping 82 and the sheet of material 10a in the direction toward the fourth side 22a of the sheet of material 10a (FIG. 6) until the lower surface 14a near the fourth side 22a firmly engages the upper surface 12a of the sheet of material 10a, wherein the floral grouping 82 is substantially encompassed by the sheet of material 10a, and wherein the bonding material 80 contacts a portion of the upper surface 12a of the sheet of material 10a to secure the sheet of material 10a in a wrapped position about the floral grouping 82 and thereby provide the decorative cover 84 (FIG. 7) which substantially encompasses and surrounds a substantial portion of the floral grouping 82. FIG. 7 shows the floral grouping 82 wrapped in a conical configuration to provide the decorative cover 84 for the floral grouping 82. When the floral grouping 82 is wrapped in a conical configuration, the bloom portion 90 of the floral grouping 82 is disposed substantially adjacent the open upper end 86 of the decorative cover 84, and the stem portion 92 of the floral grouping 82 is disposed substantially adjacent the lower end 88 of the decorative cover 84. At least a portion of both of the first and second printed patterns 24a and 26a should be visible on the decorative cover 84 for the floral grouping 82.

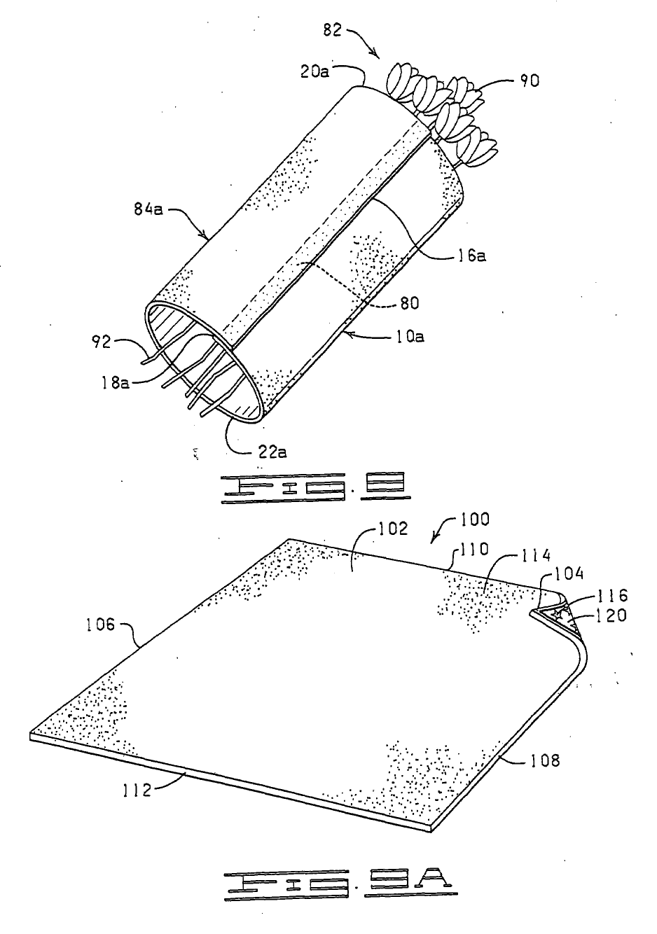

In another embodiment, illustrated in FIG. 8, the sheet of material 10a is utilized to wrap the floral grouping 82 in a cylindrical configuration. The floral grouping 82 is disposed upon the sheet of material 10a approximately parallel to the first side 16a of the sheet of material 10a. The sheet of material 10a is wrapped generally about the stem portion 92 of the floral grouping 82 to a position wherein the first side 16a of the sheet of material 10a generally overlaps the second side 18a of the sheet of material 10a in a cylindrical configuration. It should be noted that the sheet of material 10a may be wrapped a plurality of times about the stem portion 92 of the floral grouping 82 before the overlapping of the first and second sides 16a and 18a of the sheet of material 10a. As before, the portion of the sheet of material 10a near the first side 16a is disposed generally adjacent another portion of the sheet of material 10a, and the two adjacent portions then are brought into contact where they may be bondingly engaged, thereby securing the sheet of material 10a generally about the floral grouping 82 so as to provide a decorative cover 84a for the floral grouping 82. At least a portion of both of the first and second printed patterns 24a and 26a should be visible on the decorative cover 84a for the floral grouping 82.

### Description of FIGS. 9A-12

Shown in FIG. 9A is a sheet of material 100 having an upper surface 102, a lower surface 104, a first side 106, a second side 108, a third side 110 and a fourth side 112. The upper surface 102 of the sheet of material 100 is provided with a first printed pattern 114 disposed on at least a portion thereof, while the lower surface 104 of the sheet of material 100 is provided with a second printed pattern 116 disposed on at least a portion thereof. The sheet of material 100 is similar to the sheet of material 10 described herein before with reference to FIG. 1, except that the sheet of material 100 is provided with a coating of an acrylic heat sealable lacquer 120 disposed on at least one of the upper and lower surfaces 102 and 104, respectively, of the sheet of material 100. In FIG. 9A, the acrylic heat sealable lacquer 120 is shown as being disposed on the lower surface 104 of the sheet of material 100. The sheet of material 100 may be constructed of the same materials and in the same manner as that described herein previously for the sheet of material 10. Desirably, the sheet of material 100 has a thickness of about 0.5 mil to about 10 mil and more desirably in the range of from about 0.6 mil to about 1.25 mil. The second printed pattern 116 should be visible on an exposed portion of the sheet of material 100; therefore, the second printed pattern 116 may be visible through the coating of acrylic heat sealable lacquer 120, or alternatively, the second printed pattern 116 may be applied directly to the coating of acrylic heat sealable lacquer 120. Applying the second printed pattern 116 directly to the coating of acrylic heat sealable lacquer 120 may be desired when the sheet of material 100 is constructed of a material, such as cloth, which allows ink to bleed through and distort the pattern. When such type of material is utilized for constructing the sheet of material 100, both the upper and lower surfaces 102 and 104 of the sheet of material 100 may be provided with a coating of acrylic heat sealable lacquer 120 disposed thereon, and the first and second printed patterns 114 and 116 may be applied directly to the acrylic heat sealable lacquer 120 such that the first printed pattern 114 is disposed on the upper surface 102 of the sheet of material 100 in an undistorted fashion and the second printed pattern 116 is disposed on the lower surface 104 of the sheet of material 100 in an undistorted fashion.

Shown in FIG. 9B is a sheet of flexible laminated material 130 having an upper surface 132 and a lower surface 134. A first printed pattern 136 is disposed on at least a portion of the upper surface 132 of the sheet of flexible laminated material 130, while a second printed pattern 138 is disposed on at least a portion of the lower surface 134 thereof. The sheet of flexible laminated material 130 comprises a first sheet of material 140 having an upper surface 142 and a lower surface 144, and a second sheet of material 146 having an upper surface 148 and a lower surface 150. The second sheet of material 146 is laminated to at least a portion of at least one of the upper and lower surfaces 142 and 144, respectively, of the first sheet of material 140. Preferably, as shown in FIG. 9B, the upper surface 148 of the second sheet of material 146 is laminated to the lower surface 144 of the first sheet of material 140.

The first and second sheets of material 140 and 146 may be constructed from the same materials and in the same manner as that described herein before for the sheet of material 10. The first sheet of material 140 desirably has a thickness of from about 0.5 mil to about 10 ml, and more desirably from about 0.6 mil to about 1.25 mil, and the second sheet of material 146 desirably has a thickness of from about 0.5 mil to about 10 mil, and more desirably from about 0.6 mil to about 1.25 mil. While the thickness of the laminated sheet of flexible material 130 can vary widely and will generally depend on the thickness of the first sheet of material 140 and the thickness of the second sheet of material 146, desirable results can be obtained where the sheet of laminated flexible material 130 has a thickness in the range of from about 1 mil to about 20 mil, and more desirably from about 1.2 mil to about 2.5 mil.

As shown in FIG. 9B, the upper surface 148 of the second sheet of material 146 may be laminated to the lower surface 144 of the first sheet of material 140, and the first and second printed patterns 136 and 138 may be disposed on the first sheet of material 140 and/or the second sheet of material 146 such that the first and second printed patterns 136 and 138 are visible on the upper and lower surfaces 132 and 134, respectively, of the sheet of flexible laminated material 130. For example, the first printed pattern 136 may be disposed on at least a portion of the upper surface 142 of the first sheet of material 140, and the second printed pattern 138 may be disposed on the lower surface 150 of the second sheet of material 146. Alternatively, the second printed pattern 138 may be disposed on at least a portion of the lower surface 144 of the first sheet of material 140, and the second sheet of material 146 may be substantially transparent such that the second printed pattern 138 is visible through the second sheet of material 146 and is therefore visible on the lower surface 134 of the sheet of flexible laminated material 130. In this manner, the second sheet of material 146 is desirably a transparent polymeric film such that the second printed pattern 138 disposed on the lower surface 144 of the first sheet of material 140 and visible through the second sheet of material 146 is substantially water resistant.

In a further alternative, the first printed pattern 136 may be disposed on the upper surface 148 of the second sheet of material 146, and the first sheet of material 140 may be substantially transparent such that the first printed pattern 136 is visible through the first sheet of material 140 and is therefore visible on the upper surface 132 of the sheet of flexible laminated material 130. Again, when the first sheet of material 140 is formed of a substantially transparent material, such as a polymeric film, the second printed pattern 138 is substantially water resistant.

In yet another alternative, a portion of the first printed pattern 136 may be disposed on the upper surface 148 of the second sheet of material 146 and another portion of the first printed pattern 136 may be disposed on the upper surface 142 of the first sheet of material 140 which is substantially transparent. In this manner, the first printed pattern 136 may be provided with a textured or three-dimensional appearance. The second printed pattern 138 may be disposed on the lower surfaces 144 and 150 of the first and second sheets of material 140 and 146, respectively, in a similar fashion to provide the second printed pattern 138 with a textured or three-dimensional appearance.

In a further alternative, the sheet of flexible laminated material 130 may comprise three layers of sheets of material: an inner layer of cloth and two outer layers of transparent material, such as polymeric film. The layer of cloth may allow ink to bleed through, and therefore any printed pattern disposed thereon would be distorted. Therefore, to overcome this problem, a layer of transparent polymeric film having a printed pattern disposed thereon is laminated to the upper surface and the lower surface of the layer of cloth such that the sheet of flexible laminated material 130 is provided with the appearance of cloth having an undistorted printed pattern on the upper surface thereof and an undistorted printed pattern on a lower surface thereof.

Any of the above described alternatives for placement of the first and second printed patterns 136 and 138 may be used in combination. In addition, the second sheet or material 146 may be laminated to the first sheet of material 140 with a colored adhesive so as to impart a desired color to one of the upper and lower surfaces 132 and 134 of the sheet of laminated flexible material 130, such as to provide one of the printed patterns 136 or 138.

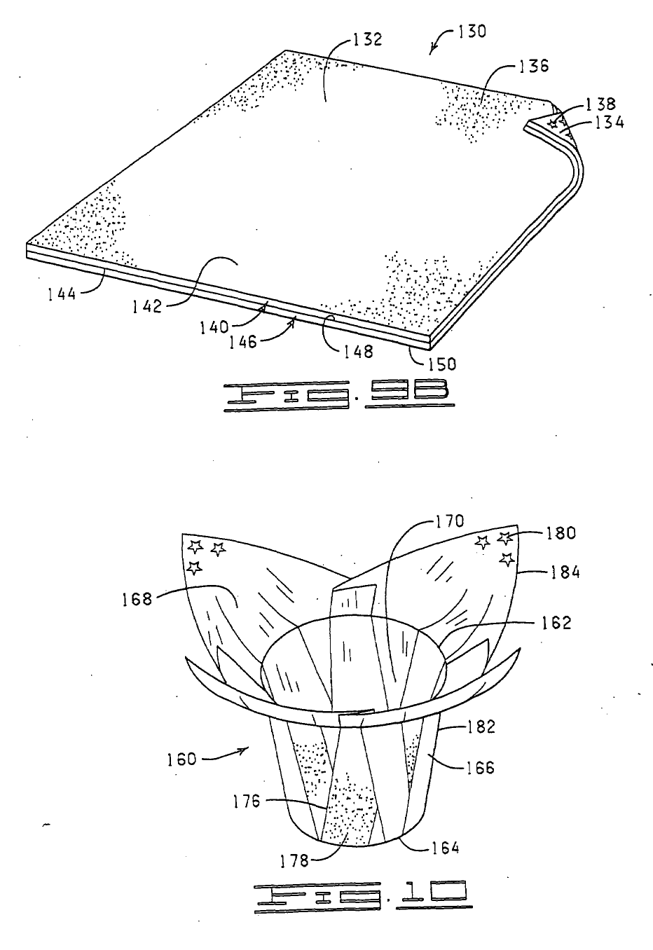

Referring now to FIGS. 10 and 11, a decorative preformed flower pot cover 160 is illustrated which may be constructed from one or more sheets of the sheet of material 10, the sheet of material 10a, the sheet of material 100, the sheet of flexible laminated material 130, or any combination thereof. The decorative preformed flower pot cover 160 has an open upper end 162, a lower end 164, an outer peripheral surface 166, an inner peripheral surface 168 and a retaining space 170 within which a flower pot 172 containing a floral grouping 174 (FIG. 11) may be disposed in a manner well known in the art. The decorative preformed flower pot cover 160 so formed will have a plurality of overlapping folds 176 formed therein, at least a portion thereof being connected. When the sheet of flexible material 100 is formed into the decorative preformed flower pot cover 160, at least a portion of the overlapping folds 176 are connected to adjacently disposed portions of the decorative preformed flower pot cover 160 via the acrylic heat sealable lacquer 120.

The decorative preformed flower pot cover 160 comprises a base portion 182 and a skirt portion 184. The base portion 182 of the decorative preformed flower pot cover 160 is dimensioned to encompass at least a portion of an outer peripheral surface 173 of the flower pot 172. The skirt portion 184 of the decorative preformed flower pot cover 160 extends outwardly from the base portion 182 of the decorative preformed flower pot cover 160 and is dimensioned to surround a portion of the flower grouping 174 disposed in the flower pot 172.

The decorative preformed flower pot cover 160 is further provided with a first printed pattern 178 and a second printed pattern 180. The first printed pattern 178 is disposed on at least a portion of the outer peripheral surface 166 of the decorative preformed flower pot cover 160, while the second printed pattern 180 is disposed on at least a portion of the inner peripheral surface 168 of the decorative preformed flower pot cover 160. At least a portion of both of the first and second printed pattern 178 and 180 are visible on the decorative preformed flower pot cover 160. The first and second printed patterns 178 and 180 may be disposed on at least a portion of the base portion 182 and/or the skirt portion 184 of the decorative preformed flower pot cover 160. That is, the second printed pattern 180 may only be disposed on the skirt portion 184 of the decorative preformed flower pot cover 160, as the inner peripheral surface 168 of the decorative preformed flower pot cover 160 is only visible on the skirt portion 184 of the decorative preformed flower pot cover 160 when the flower pot 172 is disposed in the decorative preformed flower pot cover 160, while the first printed pattern 178 may be disposed on the base portion 182 alone, the skirt portion 184 alone, or the base portion 182 and the skirt portion 184 of the decorative preformed flower pot cover 160.

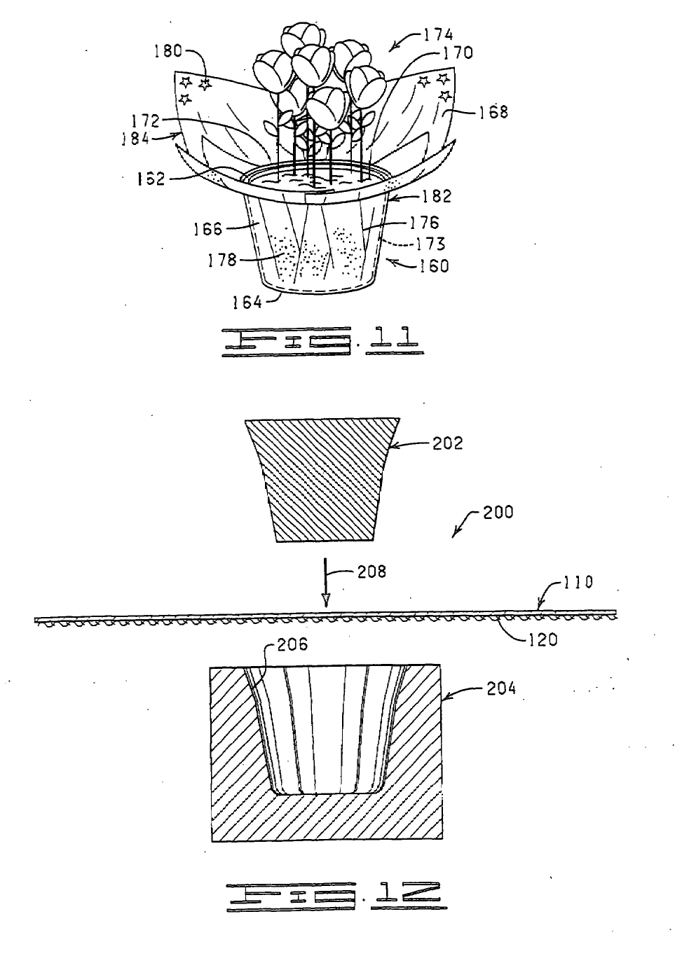

The decorative preformed flower pot cover 160 may be formed from any of the sheets of material described herein using a conventional mold system 200 as shown in FIG. 12. For the purposes of illustration, the formation of the decorative preformed flower pot cover 160 from the sheet of material 100 will be described herein with respect to FIG. 12. However, it should be understood that any of the sheets of material described herein, or any combination of the sheets of material described herein, may be utilized in the formation of the decorative preformed flower pot cover 160.

The conventional mold system 200 comprises a male mold 202 and a female mold 204 having a mold cavity 206 for matingly receiving the male mold 202. The sheet of material 100 is positioned between the male and female molds 202 and 204, respectively. Movement of the male mold 202 in the direction 208 into the mold cavity 206 forces the sheet of material 100 to be disposed about the portion of the male mold 202 disposed in the mold cavity 206 of the female mold 204 and thereby forms the sheet of material 100 into the preformed decorative flower pot cover 160 (FIGS. 10 and 11).

Further, in accordance with the present invention, the decorative preformed flower pot cover 160 constructed from the materials described herein above may have a bonding material disposed upon a portion thereof, such as when the decorative preformed flower pot cover 160 is formed of the sheet of material 10a. In this manner, the bonding material 80 may function to secure the sheet of material 10a in the shape and form of the preformed decorative flower pot cover 160 by bondingly securing a portion of the overlapping folds 176 to adjacently disposed portions of the decorative preformed flower pot cover 160 via the bonding material 80.

Methods for forming such preformed decorative pot covers are well known in the art. Two methods of forming such covers are described in U.S. Pat. Nos. 4,773,182 and 5,291,721, each of which is expressly incorporated herein by reference.

### Description of FIGS. 13-19

Shown in FIG. 13 is a sleeve designated therein by the general reference numeral 210 constructed in accordance with the present invention. The sleeve 210 may be used as a decorative cover 212 for a floral grouping (FIG. 14) or a flower pot (not shown). The sleeve 210 may be constructed from one or more sheets of the sheet of material 10, the sheet of material 10a, the sheet of material 100, the sheet of flexible laminated material 130, or any combination thereof. The sleeve 210 is provided in a generally flattened condition which is openable in the form of a tube or sleeve, and such sleeves are well known in the floral industry. The sleeve 210 has an open upper end 214, a lower end 216, an outer peripheral surface 218, an inner peripheral surface 220 and an inner retaining space 222. The sleeve 210 may be tapered outwardly from the lower end 216 toward a larger diameter at the open upper end 214 thereof. The sleeve 210 may be open at the lower end 216, or closed with a bottom at the lower end 216. When the lower end 216 of the sleeve 210 has a closed lower end 216, a portion of the lower end 216 may be inwardly folded to form one or more gussets (not shown) for allowing a lower portion of the inner retaining space 222 to be expandable, for example, for receiving the circular bottom of a pot or growing medium.

In its flattened condition, the sleeve 210 generally has an overall trapezoidal or modified trapezoidal shape, and when opened is substantially frusto-conical to coniform. It will be appreciated, however, that the sleeve 210 may comprise variations on the aforementioned shapes or may comprise significantly altered shapes such as square or rectangular, wherein the sleeve 210 when opened has a cylindrical form, as long as the sleeve 210 functions in accordance with the present invention in the manner described herein. The sleeve 210 (or any other sleeve disclosed herein) may have an angular or contoured shape. Further, the sleeve 210 may comprise any shape, whether geometric, non-geometric, asymmetrical and/or fanciful as long as it functions in accordance with the present invention. The sleeve 210 may also be equipped with drain holes (if having a closed bottom) or side ventilation holes (not shown), or can be made from gas permeable or impermeable materials.

As stated above, the sleeve 210 may be constructed from one or more sheets of the sheet of material 10, the sheet of material 10a, the sheet of material 100, the sheet of flexible laminated material 130, or any combination thereof. Any thickness of material may be utilized in accordance with the present invention as long as the sleeve 210 may be formed as described herein and as long as the formed sleeve 210 may contain at least a portion of a flower pot or a floral grouping, as described herein. Additionally, an insulating material such as bubble film, preferably as one of two or more layers, can be utilized in order to provide additional protection for the item, such as a floral grouping, contained therein.

The sleeve 210 is provided with a first printed pattern 224 and a second printed pattern 226. The first printed pattern 224 is disposed on at least a portion of the outer peripheral surface 218 of the sleeve 210, while the second printed pattern 226 is disposed on at least a portion of the inner peripheral surface 220 of the sleeve 210. The first printed pattern 224 is substantially similar to the first printed pattern 24 described in detail with reference to the sheet of material 10 of FIG. 1, and the second printed pattern 226 is substantially similar to the second printed pattern 26 described in detail with reference to the sheet of material 10 of FIG. 1.

In FIG. 14 the sleeve 162 is illustrated as having a floral grouping 228 disposed within the inner retaining space 222 of the sleeve 210. Generally, an upper or bloom portion 230 of the floral grouping 228 is disposed substantially adjacent the open upper end 214 of the sleeve 210 and a lower or stem portion 232 of the floral grouping 228 is disposed substantially adjacent the lower end 216 of the sleeve 210. The bloom portion 230 and/or the stem portion 232 of the floral grouping 228 may be disposed within the sleeve 210, or a portion of the bloom portion 230 and/or the stem portion 232 of the floral grouping 228 may extend beyond the open upper end 214 and/or the lower end 216, respectively, of the sleeve 210 and be exposed. Alternatively, either end of the sleeve 210 may be closed about the floral grouping 228. Generally, a portion of the sleeve 210 is tightened about a portion of the stem portion 232 of the floral grouping 228 for holding the decorative cover 212 about the floral grouping 228. For example, a banding element 234 may be positioned about a portion of the sleeve 210 disposed about the stem portion 232 of the floral grouping 228 so as to form a crimped portion of the sleeve 210, thereby securing the sleeve 210 in a position about the floral grouping 228 so as to form a decorative cover 212 for the floral grouping 228 substantially as shown in FIG. 14. At least a portion of both of the first and second printed patterns 224 and 226 are visible on the decorative cover 212.

The banding element 234 as used herein will be understood to refer to a string, ribbon, an elastic band, a non-elastic band, an elastic or non-elastic piece of material, a round piece of material, a flat piece of material, a piece of paper, a piece of wire, a tie wrap, a twist tie or combinations thereof.

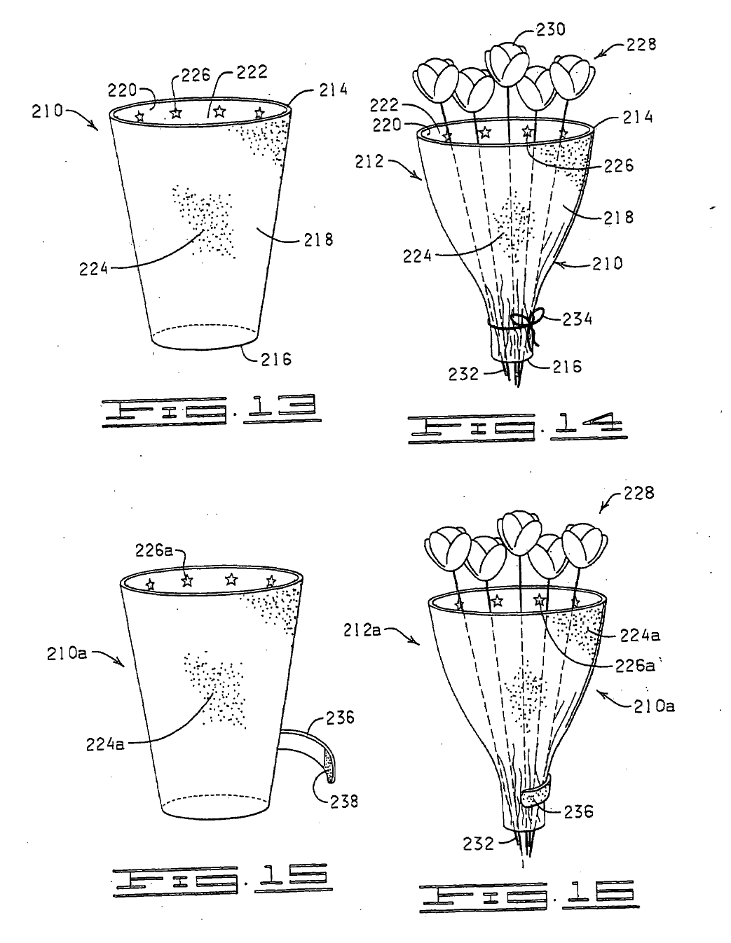

Other methods and materials for securing the sleeve 210 about the floral grouping 228 may be employed such as the bonding methods and materials described elsewhere herein. For example, as shown in FIG. 15, a sleeve 210a is shown which is provided with a first printed pattern 224a and a second printed pattern 226a and is substantially similar to the sleeve 210 except that the sleeve 210a is provided with a cinching tab 236 having a bonding material 238 disposed upon a surface thereof. The cinching tab 236 is connected to the outer peripheral surface 218 of the sleeve 210a for holding overlapping portions of the sleeve 210a in a crimped position substantially adjacent the stem portion 232 of the floral grouping 228 when the floral grouping 228 is disposed in the sleeve 210a, the bonding material 238 disposed on the cinching tab 236 engaging the overlapping portions of the sleeve 210a together so that the sleeve 210a is secured in position about the floral grouping 228, thereby forming a decorative cover 212a for the floral grouping 228, substantially as shown in FIG. 16. At least a portion of both of the first and second printed patterns 224a and 226a are visible on the decorative cover 212a.

Similarly, it may generally be desired to use the sleeve 210 as a decorative cover for a flower pot (not shown). The flower pot will generally contain a botanical item or plant. The flower pot can be deposited into the open sleeve 210 in a manner well known in the art, such as manually wherein the sleeve 210 is opened by hand and the flower pot deposited therein.

As noted above, a bonding material may be disposed on a portion of the sleeve 210 or any sleeve described herein to assist in holding the sleeve 210 to the flower pot when the flower pot is disposed within the sleeve 210 or to assist in closing the upper end 214 of the sleeve 210 or adhering the sleeve 210 to the flower pot after the flower pot has been disposed therein, as will be discussed in further detail below.

It will be understood that the bonding material, if present, may be disposed as a strip or block on a surface of the sleeve 210. The bonding material may also be disposed upon either the outer peripheral surface 218 or the inner peripheral surface 220 of the sleeve 210, as well as upon the flower pot. Further, the bonding material may be disposed as spots of bonding material, or in any other geometric, non-geometric, asymmetric, or fanciful form, and in any pattern, including covering either the entire inner peripheral surface 220 and/or outer peripheral surface 218 of the sleeve 210 and/or the flower pot. The bonding material may be covered by a cover or release strip which can be removed prior to the use of the sleeve 210 or flower pot. The bonding material can be applied by methods known to those of ordinary skill in their art. One method for disposing a bonding material, in this case an adhesive, is described in U.S. Pat. No. 5,111,637 issued to Weder et al. on May 12, 1992, entitled “Method For Wrapping A Floral Grouping”, the specification of which is hereby expressly incorporated herein by reference.

As noted above, a bonding material may be disposed on at least a portion of the inner peripheral surface 220 of the sleeve 210 (or any other sleeve described herein), or, alternatively, the bonding material may be disposed on the outer peripheral surface of a flower pot contained within the sleeve 210, while the sleeve 210 may be free of the bonding material. In a further alternative, the bonding material may be disposed both on at least a portion of the flower pot as well as upon at least a portion of the inner peripheral surface 220 of the sleeve 210. In addition, a portion of the bonding material may also be disposed on the outer peripheral surface 218 of the sleeve 210 as well. It will be understood that the bonding material may be disposed in a solid section of bonding material. The bonding material, when present, is disposed on the sleeve 210 and/or flower pot by any method known in the art.

Certain versions of sleeves described herein may be used in combination with a preformed pot cover. For example, a preformed pot cover may be applied to a flower pot, then the covered flower pot wrapped or disposed within a sleeve. Examples of sleeves which may be used in this invention are shown in the specification of U.S. Pat. No. 5,625,979 entitled “Sleeve Having A Detachable Portion Forming A Skirt And Method” issued to Weder on May 6, 1997, the specification of which is expressly incorporated herein by reference in its entirety. Equipment and devices for forming sleeves are commercially available and well known in the art.

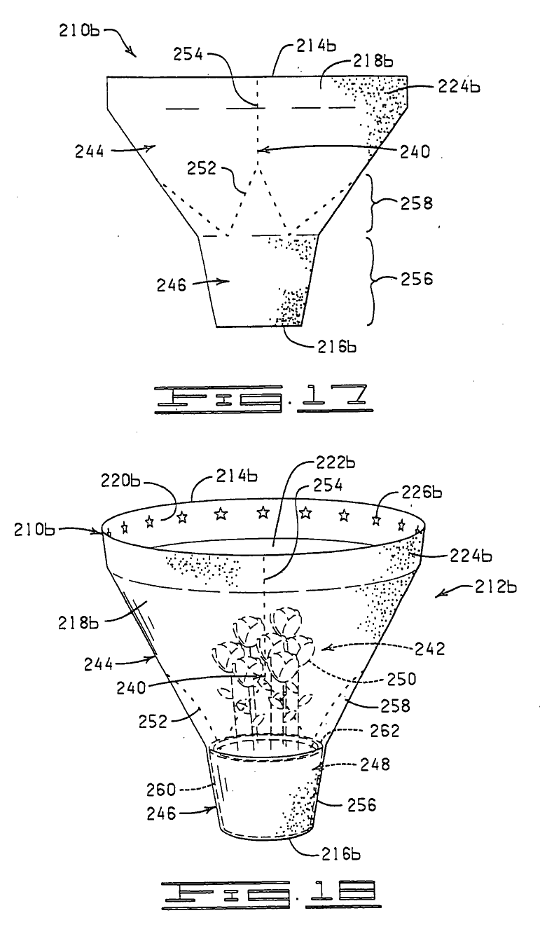

Shown in FIGS. 17-19 is another embodiment of a sleeve 210b constructed in accordance with the present invention. The sleeve 210b has a “detaching” element 240 in predetermined areas for detaching a portion of the sleeve 210b. The sleeve 210b is constructed of the same material and in the same way as described previously herein for the sleeves 210 and 210a and may be described exactly the same as the other sleeves described herein except for the additional elements described hereinafter.

The sleeve 210b has an upper end 214b, a lower end 216b, an outer peripheral surface 218b, an inner peripheral surface 220b (FIG. 18) and an inner retaining space 222b (FIG. 18). The sleeve 210b may be open at the lower end 216b or closed with a bottom at the lower end 216b. When the lower end 216b of the sleeve 210b has a closed bottom, a portion of the lower end 216b may be inwardly folded to form one or more gussets (not shown) for permitting a circular bottom of an object such as a potted plant 242 (FIG. 18) to be disposed in the inner retaining space 222b of the sleeve 210b.

The sleeve 210b is provided with a first printed pattern 224b and a second printed pattern 226b. The first printed pattern 224b is disposed on at least a portion of the outer peripheral surface 218b, and the second printed pattern 226b is disposed on at least a portion of the inner peripheral surface 220b. The first and second printed patterns 224b and 226b are substantially similar to the first and second printed patterns 24 and 26, respectively, described in detail herein with reference to the sheet of material 10 of FIG. 1.

As shown in FIGS. 17 and 18, the sleeve 210b is demarcated into an upper portion 244 and a lower portion 246 by the detaching element 240. The lower portion 246 of the sleeve 210b is generally sized to contain a flower pot 248 of the potted plant 242. The upper portion 244 of the sleeve 210b is sized to substantially surround and encompass at least a portion of a plant 250 contained in the flower pot 248 disposed within the lower portion 246 of the sleeve 210b. The sleeve 210b is demarcated into the upper portion 244 and the lower portion 246 by the detaching element 240 for enabling the detachment of the upper portion 244 of the sleeve 210b from the lower portion 246 of the sleeve 210b. In the present version, the detaching element 240 includes a plurality of generally laterally-oriented or alternatingly diagonally-oriented perforations 252 which extend circumferentially across the outer peripheral surface 218b of the sleeve 210b. The detaching element 240 may further include a plurality of vertical perforations 254 disposed in the upper portion 244 of the sleeve 210b for facilitating removal of the upper portion 244 from the lower portion 246 and which are disposed more or less vertically therein extending between the plurality of perforations 252 and the upper end 214b of the sleeve 210b.

In the embodiment shown in FIGS. 17 and 18, the lower portion 246 of the sleeve 210b further comprises a base portion 256 and a skirt portion 258. The base portion 256 comprises that part of the lower portion 246 which, when the flower pot 248 of the potted plant 242 is disposed into the lower portion 246 of the sleeve 210b, is substantially adjacent to and surrounds an outer peripheral surface 260 of the flower pot 248. The skirt portion 258 of the lower portion 246 of the sleeve 210b is attached to the base portion 256 of the lower portion 246 of the sleeve 210b and extends therefrom. The skirt portion 258 comprises that part of the lower portion 246 which extends beyond an open upper end 262 of the flower pot 248 and surrounds at least a lower portion of the plant 250 contained within the flower pot 248 so that when the upper portion 244 of the sleeve 210b is detached from the lower portion 246 of the sleeve 210b along the detaching element 240, the base portion 256 of the lower portion 246 of the sleeve 210b remains in a position surrounding the flower pot 248 and the skirt portion 258 of the lower portion 246 of the sleeve 210b extends at an angle, inwardly or outwardly, from the base portion 256 of the lower portion 246 of the sleeve 210b and is positioned about a lower portion of the plant 250, thereby forming a decorative cover 264 for the potted plant 242.

In the intact sleeve 210b, the skirt portion 258 has an upper peripheral edge congruent with the plurality of perforations 252 of the detaching element 240 which is connected to a lower peripheral edge of the upper portion 244 of the sleeve 210b, which is also congruent with the plurality of perforations 252 of the detaching element 240. In FIGS. 17 and 18, the upper peripheral edge of the skirt portion 258 is congruent with the plurality of alternatingly diagonally-oriented lines of perforations 252 which together form a zig-zag and comprise a portion of the detaching element 240.

The upper portion 244 of the sleeve 210b is thereby separable from the lower portion 246 of the sleeve 210b by tearing the upper portion 244 along the perforations 252 and 254 of the detaching element 240, thereby separating the upper portion 244 from the lower portion 246 of the sleeve 210b. The lower portion 246 of the sleeve 210b remains disposed about the potted plant 242 as the base portion 256 about the flower pot 248 and as the skirt portion 258 about the plant 250 forming the decorative cover 264 as shown in FIG. 19 which substantially surrounds and encompasses the flower pot 248 and a portion of the plant 250 contained therein. As shown in FIG. 19, the skirt portion 258 is provided with an angular upper edge 266 positioned about a portion of the plant 250 of the potted plant 242, while the base portion 256 remains in a position surrounding the flower pot 248.

As shown in FIGS. 17-19, the base portion 256 of the lower portion 246 and the upper portion 244 of the sleeve 210b may be provided with the first printed pattern 224b disposed on at least a portion of the outer peripheral surface 218b thereof, while the skirt portion 258 of the lower portion 246 and the upper portion 244 of the sleeve 210b may be provided with the second printed pattern 226b disposed on at least a portion of the inner peripheral surface 220b thereof. In this embodiment, upon detachment of the upper portion 244 of the sleeve 210b to form the decorative cover 264 about the potted plant 242, the first printed pattern 224b is visible on the base portion 256 and the second printed pattern 226b is visible on the skirt portion 258. However, it is to be understood that the first printed pattern 224b and the second printed pattern 226b may be disposed on the base portion 256 alone, the skirt portion 258 alone, the upper portion 244 alone, or any combination of the base portion 256, the skirt portion 258 and the upper portion 244 of the sleeve 210b. For example, the lower portion 246 of the sleeve 210b, including both the base and skirt portions 256 and 258, may be provided with the first printed pattern 224b, while the second printed pattern 226b is disposed on the upper portion 244 of the sleeve 210b. When the upper portion 244 is detached, the lower portion 246 of the sleeve 210b remains about the flower pot 248 of the potted plant 242 and thereby forms the decorative cover 264 about the potted plant 242 wherein the first printed pattern 224b is visible on the decorative cover 264.

“Detaching element” as used herein, refers to any element, or combination of elements, or features, such as, but not by way of limitation, perforations, tear strips, zippers, and any other devices or elements of this nature known in the art, or any combination thereof. Therefore, while perforations are shown and described in detail herein, it will be understood that tear strips, zippers, or any other “detaching elements” known in the art, or any combination thereof, could be substituted therefor and/or used therewith.

In a general method of use of the sleeve 210b as the decorative cover 212b for the potted plant 242, an operator provides the sleeve 210b and the potted plant 242 comprising the flower pot 248 and the plant 250 disposed in a growing medium contained within the flower pot 248. The operator then assures that the sleeve 210b is in an open condition and that the inner peripheral surface 220b of the sleeve 162b is somewhat expanded outward as well, as shown in FIG. 18. The operator then manually or automatically disposes the potted plant 242 in the inner retaining space 222b of the sleeve 210b, the flower pot 248 being disposed generally through the upper portion 244 of the sleeve 210b into generally the lower portion 246 of the sleeve 210b. The flower pot 248 remains in the lower portion 246 of the sleeve 210b, thereby permitting the sleeve 210b to substantially surround and tightly encompass the flower pot 248 and thereby forming the decorative cover 212b. It will be understood that alternatively, the sleeve 210b may be provided with an extension (not shown), and the sleeve 210b may be disposed on rods or wickets, and the potted plant 242 may be disposed in the sleeve 210b either before or after the sleeve 210b has been removed from the wickets.

Further, if desired the operator may remove the upper portion 244 of the sleeve 210b by tearing along the perforations 254 and 256 of the detaching element 240 to provide the decorative cover 264, wherein the skirt portion 258 is positioned adjacent a portion of the plant 250 of the potted plant 242, while the base portion 256 remains in a position surrounding the flower pot 248.

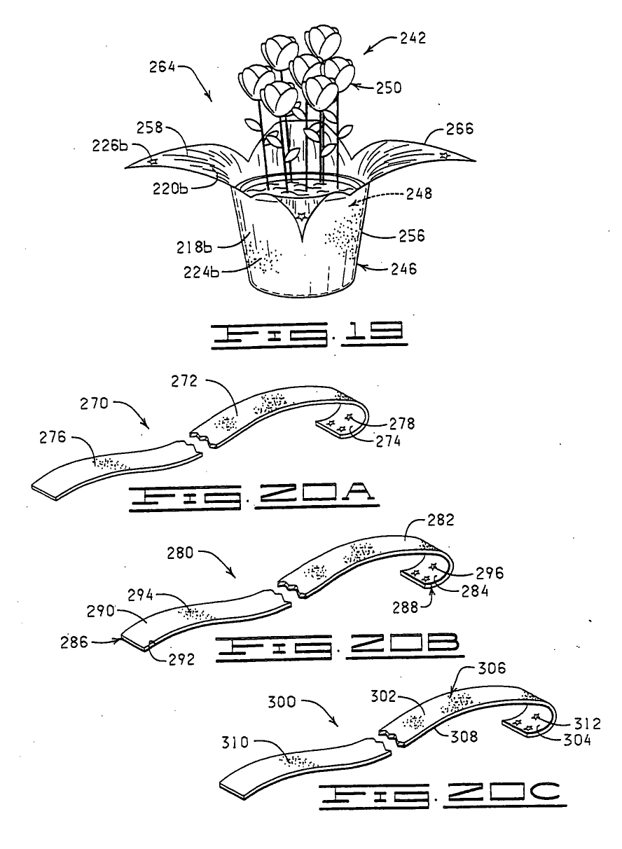

### Description of FIGS. 20A-20C

Referring now to FIG. 20A, designated generally by the reference numeral 270 is a ribbon material constructed in accordance with the present invention for wrapping items and for forming decorative bows and other decorative ornamentations containing ruffles, loops and curved segments. The ribbon material 270 may be constructed from one or more sheets of the sheet of material 10, the sheet of material 10a, the sheet of material 100, the sheet of flexible laminated material 130, or any combination thereof. For example, the material employed to produce the ribbon material 270 can be the sheet of material 10 (FIG. 1), i.e., a polypropylene film having a thickness of from about 0.1 mil to about 30 mil, and more desirably of from about 0.5 mil to about 10 ml, or the sheet of flexible material 112, i.e., an expanded core polymeric film having a thickness of from about 0.5 mil to about 10 mil. For the purposes of illustration, the ribbon material 270 is shown in FIG. 20A as constructed of the sheet of material 10. The ribbon material 270 may be produced by cutting a material into strips having a predetermined width, or the sheet of material from which the ribbon material 270 is formed may be provided with the desired predetermined width.

The ribbon material 270 is provided with an upper surface 272 and a lower surface 274. A first printed pattern 276 is disposed on at least a portion of the upper surface 272 of the ribbon material 270. A second printed pattern 278 is disposed on at least a portion of the lower surface 274 of the ribbon material 270. The first and second printed patterns 276 and 278 are substantially similar to the first and second printed patterns 24 and 26 described in detail herein before with reference to the sheet of material 10 of FIG. 1. The first printed pattern 276 and/or the second printed pattern 278 may lie within the boundaries of the ribbon material 270, or the first and/or second printed patterns 276 and 278 may be randomly disposed on the ribbon material 270.

Referring now to FIG. 20B, designated generally by the reference numeral 280 is a laminated ribbon material constructed in accordance with the present invention and utilized for wrapping items and forming decorative bows and other decorative ornamentations containing ruffles, loops and curved segments. The ribbon material 270 may be constructed from one or more sheets of the sheet of material 10, the sheet of material 10a, the sheet of material 100, the sheet of flexible laminated material 130, or any combination thereof. The laminated ribbon material 280 has an upper surface 282 and a lower surface 284 and comprises a first web or sheet of material 286 and a second web or sheet of material 288. The first sheet of material 286 has an upper surface 290, a lower surface 292 and a thickness of from about 0.5 mil to about 10 mil, and more desirably from about 0.6 mil to about 1.25 mil. The second web or sheet of material 288 is laminated to at least one of the upper and lower surfaces 290 and 292 of the first sheet of material 286, such as the lower surface 290 of the first sheet of material 286 as shown in FIG. 20B, and the second web or sheet of material 288 has a thickness of from about 0.5 mil to about 10 mil, and more desirably from about 0.6 mil to about 1.25 mil. The ribbon material 270 may be produced by cutting a material into strips having a predetermined width, or the sheet of material from which the ribbon material 270 is formed may be provided with the desired predetermined width.

A first printed pattern 294 is disposed on at least a portion of the upper surface 282 of the laminated ribbon material 280, and a second printed pattern 296 is disposed on at least a portion of the lower surface 284 of the laminated ribbon material 280. The first and second printed patterns 294 and 296 are substantially similar to the first and second printed patterns 24 and 26 described in detail herein before with reference to the sheet of material 10 of FIG. 1. The first printed pattern 294 and/or the second printed pattern 296 may lie within the boundaries of the laminated ribbon material 280, or the first and/or second printed patterns 294 and 296 may be randomly disposed on the laminated ribbon material 280.

Referring now to FIG. 20C, designated generally by the reference numeral 300 is another embodiment of a ribbon material constructed in accordance with the present invention for wrapping items and for forming decorative bows and other decorative ornamentations containing ruffles, loops and curved segments. The ribbon material 300 has an upper surface 302 and a lower surface 304 and comprises a web or sheet of material 306 having a thickness in the range of from about 0.1 mil to about 30 mil, and more desirably, from about 0.5 mil to about 10 mil, and an acrylic heat sealable lacquer 308 applied to at least one surface of the sheet or web of material 302. The ribbon material 300 may be constructed from the sheet of material 100 described in detail herein with reference to FIG. 9A. The ribbon material 300 is further provided with a first printed pattern 310 disposed on at least a portion of the upper surface 302 thereof and a second printed pattern 312 disposed on at least a portion of the lower surface 304 thereof. The first and second printed patterns 310 and 312 are substantially similar to the first and second printed patterns 24 and 26 described in detail herein with reference to the sheet of material 10 of FIG. 1. The first printed pattern 310 and/or the second printed pattern 312 may lie within the boundaries of the ribbon material 300, or the first and/or second printed patterns 310 and 312 may be randomly disposed on the ribbon material 300.

Changes may be made in the construction and the operation of the various components, elements and assemblies described herein or in the steps or the sequence of steps of the methods described herein without departing from the spirit and scope of the invention as defined in the following claims.

What is claimed:

1. A method for providing a decorative cover for a flower pot, the method comprising the steps of:
providing a flower pot having an open upper end, a lower end and an outer peripheral surface;
providing at least one sheet of material having an upper surface and a lower surface, the sheet of material being provided with a first printed pattern or color visible on the upper surface thereof and a second printed pattern or color visible on the lower surface thereof, wherein the first and second printed patterns or colors are comprised of one or more colors and wherein the first and second printed patterns or colors are different; and
wrapping the sheet of material about the outer peripheral surface of the flower pot to provide a decorative cover, the decorative cover having an outer peripheral surface and an inner peripheral surface wherein the first printed pattern or color is visible on the outer peripheral surface of the decorative cover and second printed pattern or color is visible on the inner peripheral surface of the decorative cover wherein the decorative cover is held in place about the flower pot without the use of an adhesive or cohesive to hold the decorative cover about the flower pot.

2. The method of claim 1 wherein, in the step of providing the sheet of material, the sheet of material is constructed of paper, polymeric film, metallized film, foil, cloth or combinations or laminations thereof.

3. The method of claim 2, wherein the sheet of material is a sheet of laminated material having an upper surface and a lower surface and formed of a first sheet of material having an upper surface and a lower surface and a second sheet of material having an upper surface and a lower surface, and wherein the first printed pattern or color and the second printed pattern or color are disposed on at least one of the upper and lower surfaces of one of the first and second sheets of material such that the first printed pattern or color is visible on the upper surface of the sheet of laminated material and the second printed pattern or color is visible on the lower surface of the sheet of laminated material.

4. The method of claim 1 wherein, in the step of providing the sheet of material, at least a portion of the sheet of material is provided with a coating disposed thereon, and at least a portion of at least one of the first and second printed patterns or colors is visible through the coating.

5. The method of claim 1, further comprising the step of providing an elastic band and placing the elastic band about the decorative cover to secure the decorative cover about the flower pot.

6. The method of claim 1 wherein, in the step of wrapping the sheet of material about the outer peripheral surface of the flower pot to provide a decorative cover, the open upper end of the flower pot is substantially uncovered by the decorative cover.

7. The method of claim 1 wherein, in the step of providing the sheet of material, the first and second printed patterns or colors are printed simultaneously.

8. A method for providing a decorative cover for a flower pot, the method comprising the steps of:
providing a flower pot having an open upper end, a lower end and an outer peripheral surface;
providing at least one sheet of laminated material having an upper surface and a lower surface, the sheet of material being provided with a first printed pattern or color visible on the upper surface thereof and a second printed pattern or color visible on the lower surface thereof, wherein the first and second printed patterns or colors are comprised of one or more colors and wherein the first and second printed patterns or colors are different, and wherein the sheet of laminated material is formed of a first sheet of material having an upper surface and a lower surface and a second sheet of material having an upper surface and a lower surface, and wherein the first printed pattern or color and the second printed pattern or color are disposed on at least one of the upper and lower surfaces of one of the first and second sheets of material such that the first printed pattern or color is visible on the upper surface of the sheet of laminated material and the second printed pattern or color is visible on the lower surface of the sheet of laminated material; and
wrapping the sheet of material about the outer peripheral surface of the flower pot to provide a decorative cover, the decorative cover having an outer peripheral surface and an inner peripheral surface wherein the first printed pattern or color is visible on the outer peripheral surface of the decorative cover and second printed pattern or color is visible on the inner peripheral surface of the decorative cover wherein the decorative cover is held in place about the flower pot without the use of an adhesive or cohesive to hold the decorative cover about the flower pot.

9. The method of claim 8, further comprising the step of providing an elastic band and placing the elastic band about the decorative cover to secure the decorative cover about the flower pot.

10. The method of claim 8 wherein, in the step of wrapping the sheet of material about the outer peripheral surface of the flower pot to provide a decorative cover, the open upper end of the flower pot is substantially uncovered by the decorative cover.

11. The method of claim 8 wherein, in the step of providing the sheet of material, the first and second printed patterns or colors are printed simultaneously.

12. A method for providing a decorative cover for a flower pot, the method comprising the steps of:
providing a flower pot having an open upper end, a lower end and an outer peripheral surface;
providing at least one sheet of material having an upper surface and a lower surface, the sheet of material being provided with a first printed pattern or color visible on the substantially entire upper surface thereof and a second printed pattern or color visible on the substantially entire lower surface thereof, wherein the first and second printed patterns or colors are comprised of one or more colors and wherein the first and second printed patterns or colors are different; and
wrapping the sheet of material about the outer peripheral surface of the flower pot to provide a decorative cover, the decorative cover having an outer peripheral surface and an inner peripheral surface wherein the first printed pattern or color is visible on the outer peripheral surface of the decorative cover and second printed pattern or color is visible on the inner peripheral surface of the decorative cover wherein the decorative cover is held in place about the flower pot without the use of an adhesive or cohesive to hold the decorative cover about the flower pot.

13. The method of claim 12 wherein, in the step of providing the sheet of material, the sheet of material is constructed of paper, polymeric film, metallized film, foil, cloth or combinations or laminations thereof.

14. The method of claim 13, wherein the sheet of material is a sheet of laminated material having an upper surface and a lower surface and formed of a first sheet of material having an upper surface and a lower surface and a second sheet of material having an upper surface and a lower surface, and wherein the first printed pattern or color and the second printed pattern or color are disposed on at least one of the upper and lower surfaces of one of the first and second sheets of material such that the first printed pattern or color is visible on the upper surface of the sheet of laminated material and the second printed pattern or color is visible on the lower surface of the sheet of laminated material.

15. The method of claim 12 wherein, in the step of providing the sheet of material, at least a portion of the sheet of material is provided with a coating disposed thereon, and at least a portion of at least one of the first and second printed patterns or colors is visible through the coating.

16. The method of claim 12, further comprising the step of providing an elastic band and placing the elastic band about the decorative cover to secure the decorative cover about the flower pot.

17. The method of claim 12 wherein, in the step of wrapping the sheet of material about the outer peripheral surface of the flower pot to provide a decorative cover, the open upper end of the flower pot is substantially uncovered by the decorative cover.

18. The method of claim 12 wherein, in the step of providing the sheet of material, the first and second printed patterns or colors are printed simultaneously.
